(19) United States
(12) Patent Application Publication
(10) Pub. No.: US 2009/0253568 A1
(43) Pub. Date: Oct. 8, 2009

(54) Method of making ceramic articles using proteinous material

(76) Inventors: Thomas James Deneka, Painted Post, NY (US); Andrew Charles Gorges, Addison, NY (US); David Lambie Tennent, Campell, NY (US); Christopher John Warren, Waverly, NY (US)

Correspondence Address: CORNING INCORPORATED, SP-TI-3-1, CORNING, NY, 14831, US

(21) Appl. No.: 12/080,371

(22) Filed: Apr. 2, 2008

(51) Int. Cl. C04B 35/00

(52) U.S. Cl. 501/96.2

(57) ABSTRACT

A method is disclosed for manufacturing a ceramic article that includes mixing at least one ceramic precursor inorganic ingredient, and at least one binder to form a plasticized mixture, wherein the binder includes a proteinous material. The mixture is extruded to form a green body. The green body can be heated to form the ceramic article.

### FIELD

The present invention relates to making ceramic articles by using a proteinous material, such as a protein or a protein-containing compound, and to methods of forming a batch mixture or a green body that contains a protein or protein-containing compound.

### BACKGROUND

Ceramic bodies can be formed by heating mixtures of various inorganic powders at high temperatures.

Ceramic bodies that are used in high temperature or stress environments are generally made by first forming a plasticized (“plastic”) mixture of the inorganic powders, a binder, and a liquid. The plasticized mixture is then formed into a green body, and the green body is then heated under high temperature to form the ceramic.

### SUMMARY

Disclosed herein are methods relating to making ceramic articles by using a proteinous material, such as a protein or a protein-containing compound, and to methods of forming a batch mixture or a green body that contains a protein or protein-containing compound.

In one aspect, a method of manufacturing an article comprised of ceramic is disclosed herein, the method comprising: mixing at least one ceramic precursor inorganic ingredient, and at least one binder to form a plasticized mixture, wherein the binder comprises at least one proteinous material, and forming a green body from the plasticized mixture. In some embodiments, the plasticized mixture is extruded to form the green body.

In another aspect, a method of manufacturing a ceramic article is disclosed herein, the method comprising: mixing at least one ceramic precursor inorganic ingredient, and at least one binder to form a plasticized mixture, wherein the binder comprises at least one proteinous material; forming the plasticized mixture into a green body; and heating the green body for a time and at a temperature sufficient to transform the green body into the ceramic article.

In yet another aspect, a green body for forming into an article comprised of ceramic is disclosed herein, the green body comprising at least one ceramic precursor inorganic ingredient and at least one proteinous material.

Disclosed herein are plasticized mixtures of inorganic material that can be more easily formed into green bodies at high volumetric rates and the green bodies can be used to ultimately form highly durable ceramic substrates. The mixtures help alleviate various related problems by using a binder that is resistant to significant viscosity changes at higher temperatures.

### DETAILED DESCRIPTION

In one aspect, a method of manufacturing an article comprised of ceramic is disclosed herein, the method comprising: mixing at least one ceramic precursor inorganic ingredient, and at least one binder to form a plasticized mixture, wherein the binder comprises at least one proteinous material, and forming a green body from the plasticized mixture. A green body refers to an unfired body, which can be dried or wet. In the batch or the green body, the ceramic precursor can be a ceramic-forming ingredient or a ceramic itself. The ceramic precursor can comprise, for example, an oxide source, such as a source of silica or a source of alumina, or a ceramic, such as mullite. In some embodiments, the plasticized mixture is extruded to form the green body. In some embodiments, the plasticized mixture has a T_{ONSET} of at least 25° C. In some embodiments, the plasticized mixture is shaped under shear to form a green body having a wet strength of at least 1.9 tons per square foot. In some embodiments, the proteinous material is selected from the group consisting of gluten, gliadin, glutenin, globulin and albumen. In some embodiments, the mixture contains less than 25 wt % water, based on total weight of the mixture. In some embodiments, the inorganic ingredient forms the ceramic upon heating of the green body, wherein the ceramic is selected from the group consisting of cordierite, mullite, alumina, zirconium phosphate, silicon carbide, silicon nitride, silica, and aluminum titanate. In some embodiments, the inorganic ingredient reacts to form reaction products, wherein the ceramic is a reaction product of that reaction. In some embodiments, the heating comprises curing or sintering. In some embodiments, the inorganic ingredient comprises a source of silica, alumina, or titania, or combinations thereof. In some embodiments, the mixture comprises a source of MgO, Al₂O₃, or SiO₂, or combinations thereof. In some embodiments, the mixture is extruded through a single screw extruder or twin screw extruder, and the green body has a wet strength of at least 2.0 tons per square foot. Preferably, the green body is heated to form the ceramic. In some embodiments, the binder further comprises methylcellulose. In some embodiments, the binder comprises gluten and methylcellulose.

In another aspect, a method of manufacturing a ceramic article is disclosed herein, the method comprising: mixing at least one ceramic precursor inorganic ingredient, and at least one binder to form a plasticized mixture, wherein the binder comprises at least one proteinous material; forming the plasticized mixture into a green body; and heating the green body for a time and at a temperature sufficient to transform the green body into the ceramic article. In some embodiments, the ceramic article comprises cordierite, aluminum titanate, or SiC, or combinations thereof. In some embodiments, the proteinous material is selected from the group consisting of gluten, gliadin, glutenin, globulin and albumen. In some embodiments, the binder further comprises methylcellulose. In some embodiments, the proteinous material is gluten. In some embodiments, the forming comprises extruding the plasticized mixture into a honeycombed extrudate.

In yet another aspect, a green body for forming into an article comprised of ceramic is disclosed herein, the green body comprising at least one ceramic precursor (ceramic-forming) inorganic ingredient and at least one proteinous material. In some embodiments, the green body has a honeycomb structure.

A green body can be made for use in preparing a ceramic material. The green body is formed by first mixing together a batch of material that includes at least one ceramic precursor inorganic ingredient and at least one binder, in which the binder comprises at least one proteinous material. The batch of material is mixed with a liquid solvent, such as water, in such a manner as to form a plasticized mixture. The plasticized mixture is then shaped into a green body. Preferably, the green body is dried and then the dried material is heated to form a sintered ceramic material.

Using a binder that comprises a proteinous material to form the plasticized mixture allows the plasticized mixture to be formed as a green body at very high rates because such binder is particularly tolerant to heat buildup as the green body is formed. For example, at high rates of forming the green body, such as by extrusion, the binder is less likely to become highly viscous as temperature builds during the forming process. As a result, the plasticized mixture can be extruded at high rates without becoming extremely viscous, thereby reducing high pressure requirements that are often needed during the forming of the green body at high flow rates.

Generally, a “plasticized mixture” is a complete mixture of ingredients that can be shaped, such as by extrusion, and includes inorganic ingredients, a binder, and a liquid vehicle or solvent, and optionally includes one or more pore formers or lubricants, or both. In some embodiments, the plasticized mixture is comprised of inorganic ingredients, a binder, a liquid vehicle such as water, one or more pore formers, and one or more lubricants. By plasticized is meant that the mixture is sufficiently dry so as to ensure plasticity. That is, the mixture should not contain too much liquid, particularly solvent, and therefore the material can reach a properly plasticized state. Plasticity can be achieved by controlling the amount of liquid added or making a mixture with excess solvent whereafter the mixture is dried to confer plasticity. The plasticized mixture can be readily formed into a green body. Under sufficient shear, a green body can exhibit a high degree of stiffness, yet viscosity increase during application of the shear remains relatively low compared to mixtures that are formed of binders that do not include a proteinous material.

In one embodiment, the inorganic ingredient is a powder selected from the group consisting of cordierite, mullite, alumina, zirconium phosphate, silicon carbide, silicon nitride and aluminum titanate. In some embodiments, the plasticized mixture includes at least one inorganic powder that contains a source of at least one compound selected from the group consisting of Al₂O₃, ZrO₂, Si, SiC, Si₃N₄, SiO₂, ZnO, B₂O₃, BaO, La₂O₃, TiO₂, B₂O₃ and P₂O₅.

In one embodiment, the inorganic powder that is used to form the plasticized mixture comprises at least one source of powder that forms aluminum titanate upon heating; in these embodiments, the inorganic powder preferably comprises sources of silica, alumina, and titania.

In another embodiment, the inorganic powder that is used to form the plasticized mixture comprises at least one source of powder that forms cordierite upon heating; in these embodiments, the inorganic powder preferably comprises a source of MgO, Al₂O₃ and SiO₂.

In some embodiments, the inorganic powder comprises a source of alumina (Al₂O₃); in some of these embodiments, the plasticized mixture preferably comprises from 10 wt % to 55 wt % alumina, based on total weight of the plasticized mixture, and more preferably, the mixture comprises from 15 wt % to 50 wt % alumina, and even more preferably from 20 wt % to 40 wt % alumina, based on total weight of the plasticized mixture.

In some embodiments, the inorganic powder comprises a source of titania; in some of these embodiments, the plasticized mixture preferably comprises from 10 wt % to 40 wt % titania, based on total weight of the plasticized mixture, more preferably, the mixture comprises from 15 wt % to 35 wt % titania, and even more preferably from 20 wt % to 30 wt % titania, based on total weight of the plasticized mixture. In one set of embodiments, the plasticized mixture is formed into a green body, which is then fired to form a ceramic article comprised of aluminum titanate, such as described in U.S. Pat. No. 7,001,861 to Beall et al.

In some embodiments, the inorganic powder comprises a source of MgO; in some of these embodiments, the plasticized mixture preferably comprises from 4 wt % to 25 wt % MgO, based on total weight of the plasticized mixture, more preferably, the mixture comprises from 5 wt % to 20 wt % MgO, and even more preferably from 6 wt % to 15 wt % MgO, based on total weight of the plasticized mixture.

In some embodiments, the mixture includes MgO; in some of these embodiments, at least a portion of the MgO is substituted with at least one compound selected from the group consisting of NiO, CoO, FeO, MnO and TiO₂.

In some embodiments, the inorganic powder comprises a source of silica (SiO₂); in some of these embodiments, the plasticized mixture comprises from 2 wt % to 15 wt % silica source, based on total weight of the plasticized mixture; in some of these embodiments, the plasticized mixture comprises from 3 wt % to 12 wt % silica source; in some of these embodiments, the plasticized mixture comprises from 4 wt % to 10 wt % silica source, based on total weight of the plasticized mixture. In one set of embodiments, these proportions of silica source are present in batches that comprise sources of silica, alumina and titania.

In other embodiments, the plasticized mixture comprises from 25 wt % to 55 wt % silica (SiO₂), based on total weight of the plasticized mixture; in some of these embodiments, the plasticized mixture comprises from 28 wt % to 50 wt % silica; in some of these embodiments, the plasticized mixture comprises from 30 wt % to 45 wt % silica, based on total weight of the plasticized mixture. In one set of embodiments, these proportions of silica source are present in batches that comprise sources of MgO, Al₂O₃ and SiO₂.

The binder comprises a proteinous material. The proteinous material is selected from the group consisting of proteins and protein-containing compounds, and combinations thereof. In some embodiments, the proteinous material comprises only one protein. In some embodiments, the proteinous material comprises only one protein-containing compound, such as gluten. In some embodiments, the proteinous material comprises only one protein and only one protein-containing compound. In some embodiments, the proteinous material consists of only one protein. In some embodiments, the proteinous material consists of only one protein-containing compound, such as gluten. In some embodiments, the proteinous material consists of only one protein and only one protein-containing compound. In some embodiments, the binder further comprises a non-proteinous material, such as a cellulose-based compound, for example methylcellulose. In some embodiments, the binder comprises from 2 wt % to 8 wt % superaddition to the total inorganic batch ingredients; in some of these embodiments, the binder comprises from 3 wt % to 6 wt % superaddition to the total inorganic batch ingredients; in some of these embodiments, the binder comprises from 3.5 wt % to 5 wt % superaddition to the total inorganic batch ingredients. In some embodiments, the proteinous material constitutes greater than 25% by weight of the binder; in some of these embodiments, the proteinous material constitutes greater than 40% by weight of the binder; in some of these embodiments, the proteinous material constitutes greater than 50% by weight of the binder; in some of these embodiments, the proteinous material constitutes greater than 75% by weight of the binder; in some of these embodiments, the proteinous material constitutes greater than 90% by weight of the binder; in some of these embodiments, the proteinous material constitutes greater than 95% by weight of the binder; in some of these embodiments, the proteinous material constitutes 100% by weight of the binder. In some embodiments, the proteinous material constitutes less than 75% by weight of the binder; in some of these embodiments, the proteinous material constitutes less than 60% by weight of the binder; in some of these embodiments, the proteinous material constitutes less than 50% by weight of the binder; in some of these embodiments, the proteinous material constitutes less than 40% by weight of the binder; in some of these embodiments, the proteinous material constitutes less than 25% by weight of the binder. In some embodiments, the proteinous material constitutes between 25% and 75% by weight of the binder; in some of these embodiments, the proteinous material constitutes between 30% and 70% by weight of the binder; in some of these embodiments, the proteinous material constitutes between 40% and 60% by weight of the binder. In one embodiment, the binder is comprised of 2.25 wt % methylcellulose and 2.25 wt % gluten, expressed in wt % superaddition to the inorganic batch materials. In another embodiment, the binder is comprised of 1.0 wt % methylcellulose and 3.5 wt % gluten, expressed in wt % superaddition to the inorganic batch materials.

The binder should contain enough of the proteinous material to effectively establish or control gelation or, in particular, the onset of gelation (indicated by gelation onset temperature T_{ONSET}) of the plasticized mixture. In some embodiments, the binder is comprised of at least 10 wt % of the proteinous material, based on total weight of the binder; in some of these embodiments, the binder is comprised of at least 20 wt %; in some of these embodiments, the binder is comprised of at least 25 wt % of the proteinous material.

In some embodiments, the proteinous material has a high molecular weight; in some embodiments, the proteinous material has a molecular weight of at least 5 kD; in some of these embodiments, the proteinous material has a molecular weight of at least 10 kD; in some of these embodiments, the proteinous material has a molecular weight of at least 20 kD.

The molecular weight of the proteinous material should not be so high as to negatively affect viscosity with regard to formation of the green body. In some embodiments, the proteinous material has a molecular weight of not greater than 1,000 kD; in some of these embodiments, the proteinous material has a molecular weight of not greater than 900 kD; in some of these embodiments, the proteinous material has a molecular weight of not greater than 800 kD.

The binder containing proteinous material can be highly resistant to gelation at increased temperatures. Typically gelation temperature defines the point at which the binder component undergoes a thermal transition phase. When this thermal transition occurs, the result is typically an undesirable increase in viscosity or stiffness. Because the binder is mixed with other materials to form a plasticized mixture, it is more practical to measure the batch gelation temperature.

Batch gelation temperature effects can be effectively measured as onset temperature. The “batch” as used herein refers to the mixture of compounds that are mixed together to form the plasticized mixture, which is then shaped into a green body. To measure onset temperature (T_{ONSET}) as reported herein, the batch stiffening temperature of batch samples (i.e., the plasticized mixture) is measured using capillary temperature sweep. A Malvern RH7 capillary rheometer is used to extrude batch material through two OEM capillary dies made of tungsten carbide. One die has an L/d of 16 (1 mm diameter) while the other is an orifice die with an L/d of 0.25. A batch of plasticizable material is extruded at a linear extrudate velocity of 12.7 mm/s at a temperature ramp rate of 1° C./min.

Data from the orifice die can be used to determine T_{ONSET}, because such die typically produces a flat baseline pressure during the temperature ramp. Starting at five degrees above the initial temperature of the scan, pressure is averaged over the next 15 degrees. The average pressure over this 15° C. window is termed P_{avg}. A baseline pressure can be established from the fifteen degree window. Once P_{avg} is obtained, a pressure is next calculated that is 15% higher than this value. T_{ONSET} is taken to be the temperature which is at a value 1.15 P_{avg}. On an extruder that is operating near binder gel point, an increase in extrusion pressure of 15% above a stable pressure is indicative of a significant change in batch rheology related to the binder transition.

In some embodiments, the plasticized mixture has a T_{ONSET} of at least 25° C.; in some of these embodiments, the plasticized mixture has a T_{ONSET} of at least 30° C.; in some of these embodiments, T_{ONSET} is at least 35° C.; in some of these embodiments, T_{ONSET} is at least 40° C.

In some embodiments, the proteinous material is gluten. In some embodiments, the gluten is comprised of at least 50 weight percent of protein; in some of these embodiments, the gluten is comprised of at least 75 weight percent of protein; in some of these embodiments, the gluten is comprised of at least 85 weight percent of protein. Examples of other suitable proteinous materials include gliadin, glutenin, globulin, and albumin.

Gliadin is a prolamin, which is a vegetable protein. In one example, wheat gliadin contains about 52.7 percent of carbon, about 17.7 percent of nitrogen, about 21.7 percent of oxygen, about 6.9 percent of hydrogen, and about 1.0 percent of sulfur; and it is composed of 18 amino acids, about 40 weight percent being glutamic acid.

Glutenin is one of the proteins present in wheat flour in substantial percentage. Glutenin is composed of 18 amino acids.

Globulin is a general name for a member of a heterogeneous group of serum proteins precipitated by 50 percent saturated ammonium sulfate, and thus differing from albumin, the protein present in greatest concentration in normal serum. Globulin generally may be coagulated by heat, is insoluble in water, and is soluble in dilute solutions of salts, strong acids, and strong alkalis.

Albumin is a widely-occurring water-soluble protein which can be readily coagulated by heat. Albumin further hydrolyzes to alpha-amino acids or their derivatives.

In some embodiments, the proteinous material contains at least about 80 weight percent of protein. In other embodiments, the proteinous material contains from about 5 to about 15 weight percent of lipids. In yet other embodiments, the proteinous material contains from about 0.5 to about 10 weight percent of carbohydrates.

In some embodiments, the proteinous material has a particle size distribution, as measured when the proteinous material is dry (containing less than about 0.1 weight percent of moisture) such that substantially all of the proteinous material particles (preferably at least 99 percent of the particles) are smaller than about 250 microns. In some embodiments, the proteinous material has an average particle size of not greater than about 150 microns. In some embodiments, substantially all of the proteinous material particles (preferably at least 99 percent of the particles) are smaller than about 250 microns, and the proteinous material has an average particle size of not greater than about 150 microns.

The proteinous material can contain other components besides proteins or protein-containing compounds. These components can be associated with the protein portion through either chemical or mechanical association, including association as a simple mixture.

In some embodiments, the binder further comprises at least one cellulose-based compound. Preferably, the at least one cellulose-based compound is selected from the group consisting of methyl cellulose, ethylhydroxy ethyl cellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, and sodium carboxy methylcellulose, and combinations thereof.

In some embodiments, the binder is comprised of less than 90 wt % of any one cellulose-based compound, based on total weight of the binder; in some of these embodiments, the binder comprises less than 80 wt % of any one cellulose-based compound; in some of these embodiments, the binder is comprised of less than 75 wt % of any one cellulose-based compound, based on total weight of the binder, if any. In some embodiments, the total content of cellulose-based compound or compounds, if any are present, in the binder is less than 90 wt %, based on total weight of the binder; in some of these embodiments, the total content of cellulose-based compound or compounds, if any are present, in the binder is less than 80 wt %; in some of these embodiments, the total content of cellulose-based compound or compounds, if any are present, in the binder is less than 75 wt %, based on total weight of the binder.

The mixture can further comprise at least one processing aid selected from the group consisting of lubricants, plasticizers, pore formers and solvents. Preferably, the mixture comprises water as the solvent. The mixture should not contain too much liquid solvent (e.g. water) so that the material can be at the properly plasticized state prior to forming into a green body. In some embodiments, the plasticized mixture contains less than 25 wt % solvent, based on total weight of the mixture; in some of these embodiments, the mixture contains less than 20 wt % solvent; in some of these embodiments, the mixture contains less than 15 wt % solvent, based on total weight of the mixture. In some embodiments, the plasticized mixture contains less than 25 wt % water, based on total weight of the mixture; in some of these embodiments, the mixture contains less than 20 wt % water; in some of these embodiments, the mixture contains less than 15 wt % water, based on total weight of the mixture.

The green body that is formed from the plasticized mixture is preferably formed by applying a stress, such as due to shear, to the plasticized mixture, such as by passing the mixture through a screw extruder, such as a single screw or twin screw extruder. The green body that is formed is self-standing and can exhibit a high degree of stiffness.

As used herein, wet strength is measured by an ELE International Penetrometer, 29-3729. Preferably, the plasticized mixture is shaped under shear to form a green body having a wet strength of at least 1.9 tons per square foot, more preferably at least 2.0 tons per square foot, and even more preferably at least 2.5 tons per square foot.

In some embodiments, the plasticized mixture is prepared by first mixing the inorganic powder and binder in a solvent to provide the plasticized mixture. Solvent can be removed from the mixture by, for example, oven drying or spray drying.

In some embodiments, the inorganic powder is mixed together with the binder and then solvent is added to form the plasticized mixture. The plasticized mixture is then formed into a green body. The individual components of the binder system can be mixed together with the inorganic powder to prepare a preferably intimate mixture of the ceramic material and the binder system. For example, all components of the binder system may be previously mixed with each other, and the binder mixture can then be mixed together with the inorganic powder. Alternatively, the components of binder system may be added to the inorganic powder one after another, or each previously prepared mixture of two or more components of the binder system may be added. Preferably, the inorganic powder and binder components are uniformly mixed, for example by kneading.

The resulting plasticized mixture can then be shaped into a green body, for example by extrusion, particularly through an extrusion die, injection molding, slip casting, centrifugal casting, pressure casting, or dry pressing. In some embodiments, the forming process provides a high degree of shear to the resulting green body.

The prepared green body can then be dried, for example, by hot-air, microwave or dielectric drying.

Firing conditions can vary depending on the process conditions such as specific composition, size of the green body, and nature of the equipment. In some embodiments, the firing conditions can comprise heating the green body to a temperature of from about 1350° C. to about 1450° C., and holding at in this temperature range for about 6 hours to about 16 hours, and thereafter cooling the formed ceramic material back to room temperature. In one set of embodiments, the green body is fired to form a ceramic article comprised of aluminum titanate, such as described in U.S. Pat. No. 7,001,861 to Beall et al.

The ceramic article that is produced from the green body can be used, for example, as a catalytic support or flow through substrate, or a filter, such as particulate filters (e.g. diesel particulate filters) used to treat exhaust streams. The ceramic is preferably a porous ceramic.

In some embodiments, the ceramic article is a multicellular structure such as a honeycomb structure. Honeycombs are multicellular bodies having an inlet and outlet end or face, and a multiplicity of walls defining the cells or channels. In wall flow filters, the walls are porous. Honeycomb cell densities can range, for example, from about 10 cells/in² (1.5 cells/cm²) to about 600 cells/in² (93 cells/cm²).

The multicellular structure preferably has surfaces with pores which extend into the structure. In one embodiment, at least a portion of the cells is plugged. In some embodiments, the plugging is at the ends of the cells. In some embodiments, a portion of the cells on the outlet end but not corresponding to those on the inlet end are plugged.

In a plugged type honeycomb filter, an exhaust stream flows into the structure through the open cells at the inlet end, then through the porous cell walls, and out of the structure through the open cells at the outlet end. Filters of this type are typically referred to as a “wall flow” filters, since the flow paths resulting from channel plugging, (e.g. alternate channel plugging) require the fluid being treated to flow through the porous ceramic walls prior to exiting the filter. Cross flow structures can also be used.

### EXAMPLES

The invention will be further clarified by the following examples.

Batches of dry powders were made by mixing together inorganic powders as raw materials. The raw materials were then mixed with additives including pore formers and binder in a Littleford to obtain a homogeneous dry blend. Other suitable mixers could be used instead. The batch was then transferred to a plasticizing mixer (or muller) and water was added to the dry components in an amount sufficient to form a plasticized batch. Optionally, the inorganic powders, pore formers, and binders could be dry mixed together, then water added to the dry mixture in a Littleford or other suitable mixer. The resulting mix was blended for about 10-15 minutes to make a plasticized mixture. The plasticized mixture was then extruded to form a green body. The wet strength and T_{ONSET} were measured for the green body. The results of one set of batches are shown in Table 1, and results of another set of batches are shown in Table 2.

TABLE 1

| | Batch 1 | Batch 2 | Batch 3 |
|---|---|---|---|
| Ingredients | Wt % | Wt % | Wt % |
| Inorganics* | | | |
| Silica (SiO2) | 10.19 | 10.19 | 10.19 |
| (MPS = 26) | | | |
| Strontium Carbonate (SrCO₃) | 8.00 | 8.00 | 8.00 |
| (MPS = 6) | | | |
| Calcium Carbonate (CaCO₃) | 1.38 | 1.38 | 1.38 |
| (MPS = 2.5) | | | |
| Alumina, Calcined (Al₂O₃) | 46.57 | 46.57 | 46.57 |
| (MPS = 12) | | | |
| Titanium Dioxide (TiO₂) | 29.95 | 29.95 | 29.95 |
| (MPS = 0.5) | | | |
| Alumina, Hydrate (AL(OH)₃) | 3.71 | 3.71 | 3.71 |
| (MPS = 3.5) | | | |
| Lanthanum Oxide (La₂O₃) | 0.20 | 0.20 | 0.20 |
| (MPS = 8) | | | |
| Total | 100.00 | 100.00 | 100.00 |
| Additives - Superaddition | | | |
| (pore formers; binder) | | | |
| Graphite | 10.00 | 10.00 | 10.00 |
| Potato Starch | 8.00 | 8.00 | 8.00 |
| Methylcellulose | 4.50 | 2.25 | 1.00 |
| Gluten | — | 2.25 | 3.50 |
| Tall Oil Fatty Acid | 1.00 | 1.00 | 1.00 |
| Water | 15.50 | 15.50 | 15.50 |
| wet strength | 1.75 | 2.0 | 2.75 |
| (tons per square foot) | | | |
| T_{ONSET} | 41.7 | 51.2 | 59.4 |
| (° C.) | | | |

*MPS = median particle size (in microns)

TABLE 2

| | Batch 4 | Batch 5 | Batch 6 |
|---|---|---|---|
| Ingredients | Wt % | Wt % | Wt % |
| Inorganics* | | | |
| Silica (SiO₂) | 12.5 | 12.5 | |
| (MPS = 26) | | | |
| Silica (SiO₂) | | | 6.75 |
| (MPS = 5) | | | |
| Talc | 40.7 | 40.7 | |
| (MPS = 24) | | | |
| Talc | | | 40.38 |
| (MPS = 14) | | | |
| Kaolin, Hydrous | 16 | | |
| (MPS = 3) | | | |
| Kaolin, Hydrous | | 16 | |
| (MPS = 1) | | | |
| Kaolin, Hydrous | | | 15.28 |
| (MPS = 1) | | | |
| Kaolin, Calcined | | | 18.33 |
| (MPS = 3) | | | |
| Alumina, Calcined (Al₂O₃) | 14.8 | 14.8 | 14.45 |
| (MPS = 7) | | | |
| Alumina, Calcined (Al₂O₃) | | | 4.81 |
| (MPS = 0.5) | | | |
| Alumina, Hydrate (AL(OH)₃) | 16 | 16 | |
| (MPS = 3.5) | | | |
| Total | 100.00 | 100.00 | 100.00 |
| Additives (superaddition) | | | |
| (pore formers; binder) | | | |
| Potato Starch | 10 | 10 | — |
| Methylcellulose | 4 | 2 | 1.4 |
| Gluten | 1 | 2 | 1.4 |
| Tall Oil Fatty Acid | | | 0.2 |
| Sodium Stearate Liga | 1 | 1 | 0.4 |
| Water | 22 | 19 | 28 |
| T_{ONSET} | 42.1 | 49.0 | 65.6 |
| (° C.) | | | |

*MPS = median particle size (in microns)

Tables 1 & 2 show that as the amount of proteinous material (e.g., gluten) in the total amount of binder (e.g., methylcellulose+gluten) was increased, the higher the wet strength. Likewise, as the amount of protein-containing compound in the total amount of binder was increased, T_{ONSET} increased. T_{ONSET} increases for batches with proteinous material compared to batches with cellulose-based binders alone (i.e. no proteinous material) In addition, no substantial increase in pressure was observed over time as the plasticized material was extruded and as the wet strength was increased.

The principles and modes of operation of this invention have been described above with reference to various exemplary and preferred embodiments. As understood by those of skill in the art, the overall invention, as defined by the claims, encompasses other preferred embodiments not specifically enumerated herein.

1. A method of manufacturing an article comprised of a ceramic, the method comprising:
mixing at least one ceramic precursor inorganic ingredient, and at least one binder to form a plasticized mixture, wherein the binder comprises at least one proteinous material; and
extruding the plasticized mixture and forming a green body from the extruded plasticized mixture.

2. The method of claim 1, wherein the plasticized mixture has a T_{ONSET} of at least 25° C.

3. The method of claim 1, wherein the plasticized mixture is shaped under shear to form a green body having a wet strength of at least 1.9 tons per square foot.

4. The method of claim 1, wherein the proteinous material is selected from the group consisting of gluten, gliadin, glutenin, globulin and albumen.

5. The method of claim 1, wherein the plasticized mixture contains less than 25 wt % water, based on total weight of the mixture.

6. The method of claim 1, wherein the inorganic ingredient forms the ceramic upon heating of the green body, wherein the ceramic is selected from the group consisting of cordierite, mullite, alumina, zirconium phosphate, silicon carbide, silicon nitride, silica, and aluminum titanate.

7. The method of claim 1, wherein the inorganic ingredient comprises a source of silica, alumina, or titania, or combinations thereof.

8. The method of claim 1, wherein the mixture comprises a source of MgO, Al₂O₃, or SiO₂, or combinations thereof.

9. The method of claim 1, wherein the mixture is extruded through a single screw extruder or twin screw extruder, and wherein the green body has a wet strength of at least 1.9 tons per square foot.

10. The method of claim 1 wherein the green body is heated to form the ceramic.

11. The method of claim 1 wherein the binder further comprises methylcellulose.

12. The method of claim 1 wherein the binder comprises gluten and methylcellulose.

13. A method of manufacturing a ceramic article, the method comprising:
mixing at least one ceramic precursor inorganic ingredient, and at least one binder to form a plasticized mixture, wherein the binder comprises at least one proteinous material;
forming the plasticized mixture into a green body;
heating the green body for a time and at a temperature sufficient to transform the green body into the ceramic article.

14. The method of claim 13 wherein the ceramic article comprises cordierite, aluminum titanate, or SiC, or combinations thereof.

15. The method of claim 14 wherein the proteinous material is selected from the group consisting of gluten, gliadin, glutenin, globulin and albumen.

16. The method of claim 15 wherein the binder further comprises methylcellulose.

17. The method of claim 16 wherein the proteinous material is gluten.

18. The method of claim 13 wherein the forming comprises extruding the plasticized mixture into a honeycombed extrudate.

19. A green body for forming into an article comprised of ceramic, the green body comprising at least one ceramic precursor inorganic ingredient and at least one proteinous material.

20. The green body of claim 19 wherein the green body has a honeycomb structure.
